(19) United States
(12) Patent Application Publication
(10) Pub. No.: US 2009/0268861 A1
(43) Pub. Date: Oct. 29, 2009

(54) Plutonium/Zirconium Hydride/Thorium Fuel Matrix

(75) Inventor: Zeev Shayer, Lone Tree, CO (US)

Correspondence Address: CHRISTOPHER J. KULISH, P.C., 1531 Norwood Avenue, Boulder, CO, 80304, US

(73) Assignee: UNIVERSITY OF DENVER, Denver, CO (US)

(21) Appl. No.: 11/719,284

(22) PCT Filed: Nov. 14, 2005
(86) PCT No.: PCT/US05/40978

§ 371 Date: May 14, 2007

Related U.S. Application Data
(60) Provisional application No. 60/522,852, filed on Nov. 12, 2004.

(51) Int. Cl. G21C 3/00

(52) U.S. Cl. 376/409

(57) ABSTRACT

The present invention is directed to a plutonium-based nuclear fuel that is suitable for burning weapon-grade and reactor-grade plutonium in a light water reactor, thereby reducing the amount of such material that could potentially be used to manufacture a weapon. In one embodiment, the fuel is comprised of plutonium, zirconium hydride, and thorium, with the zirconium hydride comprising more than about 20% by weight of the fuel.

### FIELD OF THE INVENTION

The present invention is directed to a plutonium based nuclear fuel that is suitable for use in a light water reactor (LWR) and the use of such a fuel in a LWR.

### BACKGROUND OF THE INVENTION

Presently, there are approximately 150 metric tons of known weapons-grade plutonium and approximately 850 metric tons of known reactor-grade plutonium in the world, with 50 metric tons of reactor-grade plutonium being produced every year. There is likely to be more such plutonium in the world that is unaccounted for. Since these types of plutonium can be used to make weapons of mass destruction, such as thermonuclear bombs and dirty bombs, it is desirable to process any such plutonium so as to render the plutonium difficult to use in making a weapon of mass destruction or to transform any such plutonium into a form that is difficult to use in making any kind of weapon of mass destruction.

Currently, there are two approaches to processing weapons-grade and reactor-grade plutonium such that the end product is either difficult or substantially impossible to use in constructing a weapon of mass destruction. The first approach is to immobilize the plutonium. Typically, this approach involves immobilizing plutonium powder in a glass matrix and then placing the plutonium/glass matrix in a secure storage location. The second approach is to incorporate the plutonium in a nuclear fuel that is burned at a nuclear power plant. The burning of such a fuel results in much of the plutonium being transformed into an isotope that is unsuitable for use in a weapon of mass destruction. Presently, a plutonium-based nuclear fuel that is being used to reduce the supply of plutonium that might be used to produce a weapon is a blend of plutonium-239 and natural or depleted uranium, which is commonly referred to as a mixed oxide fuel (MOX).

### SUMMARY OF THE INVENTION

The present invention is directed to a plutonium-based nuclear fuel that is suitable for use in a light water reactor (LWR) that is used to generate electricity and in which ordinary water is used as the moderator and coolant. There are two types of LWR, namely, a pressurized water reactor (PWR) and a boiling water reactor (BWR). The plutonium-based nuclear fuel is comprised of plutonium, zirconium hydride, and thorium. In one embodiment, the zirconium hydride comprises 20-50% by weight of the fuel. In another embodiment of the fuel, the plutonium is less than 10% by weight of the fuel; the zirconium hydride is 20-50% by weight of the fuel; and the thorium is 20-50% by weight of the fuel. In another embodiment of the fuel, about 40-94% of the plutonium in the fuel is plutonium-239. A further embodiment fuel comprises a zirconium hydride in which the hydrogen to zirconium ratio is in the range of about 1.6-1.8. The present invention is also directed to the use of such a fuel in an LWR reactor, e.g., a TRIGA reactor.

### BRIEF DESCRIPTION OF THE DRAWINGS

FIG. 1 is a chart that shows the variation in K_{∞}, versus burnup for a particular composition of Pu/ZrHx/Th, a first composition of MOX that comprises natural uranium, a second composition of MOX that comprises uranium-235, and a particular composition of uranium oxide (UO₂); and

FIG. 2 is a chart that shows the Pu-239 remaining versus burnup for the composition of Pu/ZrHx/Th shown in FIG. 1 and the second composition of MOX shown in FIG. 1.

### DETAILED DESCRIPTION

The present invention is a nuclear fuel that is suitable for use in a LWR that generates electricity and is comprised of plutonium, zirconium hydride, and thorium. The nuclear fuel is comprised of more than 20% by weight of zirconium hydride. Typically, the plutonium (Pu) is less than 10% by weight of the fuel; the zirconium hydride (ZrHx) is 20-50% by weight of the fuel; and the thorium (Th) is 20-50% by weight of the fuel. It is anticipated that the plutonium portion of the fuel will be substantially comprised of plutonium-239, the predominate plutonium isotope in weapon-grade and reactor-grade plutonium. In one embodiment, about 40-94% of the plutonium in the fuel is plutonium-239.

The zirconium hydride portion of the fuel provides hydrogen that, during use in a LWR reactor, provides neutron moderation and thereby enhances incineration of the plutonium present in the fuel by forcing more neutrons into the plutonium. More specifically, the hydrogen enhances the neutron absorption probability in the 0.3 eV resonance peak of Pu-239. In one embodiment, the hydrogen to zirconium ratio is in the range of about 1.6-1.8.

The thorium portion of the fuel, during use in a reactor, provides additional fissile material through conversion of Th-232 to U-233, which increases the discharge burnup values relative to MOX fuel comprised of low-enriched uranium (LEU). Further, during use of the reactor, some of the Th-232 will absorb a neutron to become Th-233. The Th-233 produces highly radioactive daughter products, such as Thallium-208. The presence of such highly radioactive isotopes in the spent fuel makes the spent fuel very difficult to use in the manufacture of a weapon.

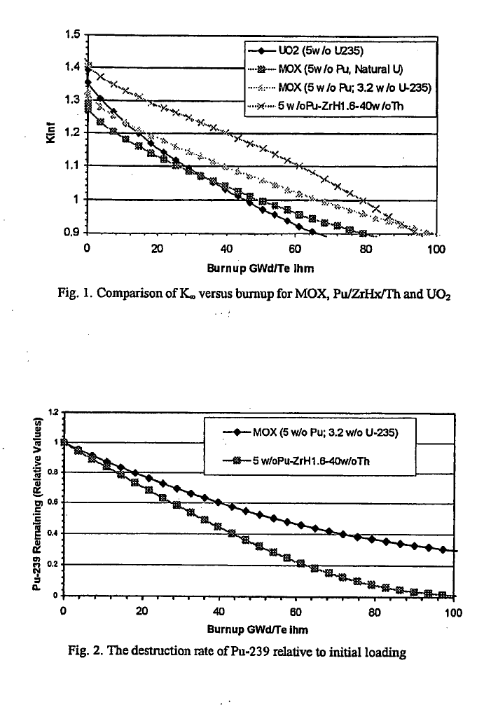

With reference to FIG. 1, infinite pin cell calculations performed by WIMSD-5B², a deterministic code for reactor core lattice calculations, show that a particular composition of Pu/ZrHx/Th has a considerably better burnup figure relative to two different compositions of MOX and a uranium oxide fuel (UO₂), MOX and UO₂ represent the two very common types of fuel used in PWRs. As can be seen from FIG. 1, at a K_{∞} of about 1, the Pu/ZrHx/Th fuel has a burnup value of about 80,000 Gigawatt days/metric ton (GWd/Te). In contrast, the next best fuel, the 5 w/o Pu-3.2 w/o U-235 MOX fuel, has a burnup value of about 65,000 GWd/Te for a K_{∞} of about 1.

With reference to FIG. 2, the calculations show that the destruction rate of Pu-239 for the Pu/ZrHx/Th composition discussed with respect to FIG. 1 is considerably better than the 5 w/o Pu-3.2 w/o U-235 MOX fuel that was also discussed with respect to FIG. 1. More specifically, the destruction rate of Pu-239 is significantly better than the MOX fuel. Specifically, at 50,000 GWd/Te for MOX fuel, only 50% of initial Pu-239 is consumed as compared to 70% for the Pu/ZrHx/Th fuel composition. This value is increase to 92% for the Pu/ZrHx/Th matrix fuel as compared to only 63% for MOX at 80,000 GWd/Te.

It should also be appreciated that the concentration of Pu in the spent Pu/ZrHx/Th fuel is significantly less than the concentration of Pu in a spent MOX fuel and comparable to the Pu concentration in spent uranium oxide fuel. Specifically, the concentration of Pu in the spent Pu/ZrHx/Th fuel is about 0.35-0.38; the concentration of Pu in spent MOX fuel is about 1.5-2.0; and the concentration of Pu in spent uranium oxide fuel is about 0.4. Moreover, it should be appreciated that since the fertile material in MOX is U-238 and U-238 can be used to produce Pu-239, in some cases, the concentration of Pu-239 in a spent MOX fuel can be higher than the Pu-239 concentration in the original or unspent MOX fuel.

While the nuclear fuel is believed to be capable of being manufactured by any of the processes known for making nuclear fuels that employ zirconium hydride, the most promising process for manufacturing the nuclear fuel is the process that has been used to manufacture U—ZrH_{1.6} for TRIGA reactors. The method is disclosed in the General Atomics report GA-A16029 by M. T. Simnad and entitled, “The U—ZrHx Alloy: Its Properties and Use in TRIGA Fuel” (August 1980), which is incorporated herein by reference in its entirety.

The nuclear fuel described hereinabove is capable of being used in a PWR or a BWR. One example of a PWR is described in U.S. Pat. No. 4,278,500, which is incorporated herein by reference in its entirety. An example of a BWR is described in U.S. Pat. No. 3,145,149, which is incorporated herein by reference in its entirety. In the case of either a PWR or a BWR, the fuel is typically surrounded by zirconium or stainless steel cladding.

The nuclear fuel may have the following advantages relative to the presently known MOX fuels: (a) increased core-life; (b) increased energy generation per fuel loading; (c) reduced waste volume and toxicity due to higher discharge number and to partial utilization of thorium; (d) utilization of thorium resources; (e) improved safety due to the large negative temperature coefficient associated with the fuel; (f) improved proliferation resistance by burning up more plutonium and the use of thorium; (g) improved thermal conductivity and fuel storage heat capacity; and (h) low fission gas release.

The foregoing is intended to explain the best mode known of practicing the invention and to enable others skilled in the art to utilize the invention.

What is claimed is:

1. A nuclear matrix fuel comprising:
plutonium;
zirconium hydride; and
thorium;
wherein said plutonium is no more than 10% by weight of the fuel;
wherein said zirconium hydride is at least 20% by weight of the fuel; and
wherein said thorium is at least 20% by weight of the fuel.

2. A nuclear matrix fuel, as claimed in claim 1, wherein:
40-94% by weight of said plutonium is plutonium-239.

3. A nuclear matrix fuel, as claimed in claim 1, wherein:
said zirconium hydride is 20-50% by weight of the fuel.

4. A nuclear matrix fuel, as claimed in claim 1, wherein:
said thorium is 20-50% by weight of the fuel.

5. A nuclear matrix fuel comprising:
plutonium-239; and
zirconium hydride;
wherein said zirconium hydride is at least 20% by weight of the fuel.

6. A nuclear matrix fuel, as claimed in claim 5, further comprising:
plutonium other than plutonium-239;
wherein at least 40% by weight of said plutonium other than plutonium-239 and said plutonium-239 is plutonium-239.

7. A nuclear matrix fuel, as claimed in claim 5, wherein:
said zirconium hydride has a hydrogen to zirconium ratio of about 1.6 to 1.8.

8. A nuclear matrix fuel comprising:
plutonium;
zirconium hydride; and
thorium;
wherein said zirconium hydride is at least 20% by weight of the fuel;
wherein 40-94% by weight of said plutonium is plutonium-239.

9. A method for reducing the ability to use plutonium-239 in a weapon comprising:
providing a light water reactor;
using a fuel in said light water reactor that is comprised of plutonium-239, zirconium hydride, and thorium.

10. A method, as claimed in claim 9, wherein:
said plutonium-239 is no more than 10% by weight of the fuel.

11. A method, as claimed in claim 9, wherein:
said zirconium hydride is at least 20% by weight of said fuel.

12. A method, as claimed in claim 9, wherein:
said thorium is at least 20% by weight of said fuel.

13. A method, as claimed in claim 9, further comprising:
plutonium other than plutonium-239.

14. A method, as claimed in claim 13, wherein:
said plutonium other than plutonium-239 and said plutonium-239 is no more than 10% by weight of the fuel.

15. A method, as claimed in claim 13, wherein:
wherein at least 40% by weight of said plutonium other than plutonium-239 and said plutonium-239 is plutonium-239.
